(19) United States
(12) Patent Application Publication
(10) Pub. No.: US 2018/0300557 A1
(43) Pub. Date: Oct. 18, 2018

(54) OBJECT ANALYSIS IN LIVE VIDEO CONTENT

(71) Applicant: Amazon Technologies, Inc., Reno, NV (US)

(72) Inventors: Paulo Miguel Almeida Rodenas, Sao Paulo (BR); Bruno Dines Emer, Sao Paulo (BR); David Renato Francisco dos Reis, Jr., Sao Paulo (BR)

(21) Appl. No.: 15/490,734

(22) Filed: Apr. 18, 2017

(51) Int. Cl. G06K 9/00; G11B 27/10; G08B 13/196; G06F 17/30

(52) U.S. Cl. CPC G06K 9/00771; G11B 27/10; G06K 9/00335; G08B 13/19613; G06F 17/3079; G06K 9/00315; G08B 13/19671; G06F 17/3082; G06K 9/00248

(57) ABSTRACT

Frames of video data from a surveillance system can be analyzed in near real time to allow for action to be taken based on the analysis. Task-based resources can be allocated to process each individual frame. Pre-processing can be performed to determine whether to analyze a given video frame. Each frame to be analyzed can be processed using at least one recognition algorithm to detect objects of interest, which can also be compared against corresponding data from earlier frames to determine relevant behaviors, moods, actions, or patterns of use. Each determination can have a corresponding confidence value. Information about the determinations and confidence levels can be analyzed to determine whether an action should be taken, as well as the type of action to take. Information for the determinations can also be used to apply tags to the video content to allow for searching and indexing of the video content.

### BACKGROUND

An increasing amount of data is being captured for almost every aspect of daily life. This includes the capturing of digital video information, such as is useful for security and monitoring. This increased amount of data requires a significant amount of additional resources for processing. In almost all cases, the video data is analyzed after a length of video data has been captured. For multiple video feeds, this can take significant effort to analyze and in many cases will require a manual review. Even where some amount of analysis is available, there will be a significant delay until the video analysis or review has been completed, which decreases the effectiveness of the monitoring in many instances.

### BRIEF DESCRIPTION OF THE DRAWINGS

Various embodiments in accordance with the present disclosure will be described with reference to the drawings, in which:

FIGS. 1A and 1B illustrate an example situation in which a location is monitored using an array of video cameras in accordance with one embodiment.

FIGS. 2A, 2B, 2C, 2D, and 2E illustrate example behaviors or characteristics of persons represented in video content that can be recognized within the scope of various embodiments.

FIG. 3 illustrates an example environment in which portions of the various embodiments can be implemented.

FIG. 4 illustrates an example resource environment for providing task-based resource allocation that can be used in accordance with various embodiments.

FIG. 5 illustrates an example resource environment for providing task-based resource allocation that can be used in accordance with various embodiments.

FIG. 6 illustrates an example resource fleet that can be utilized in accordance with various embodiments.

FIGS. 7A and 7B illustrate example interfaces for surfacing behavior information that can be utilized in accordance with various embodiments.

FIG. 8 illustrates an example process for performing near real time analysis of video content that can be utilized in accordance with various embodiments.

FIG. 9 illustrates an example process for detecting behavior in live video that can be utilized in accordance with various embodiments.

FIG. 10 illustrates components of an example computing device that can be used to implement aspects of the various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Systems and methods in accordance with various embodiments of the present disclosure may overcome one or more of the aforementioned and other deficiencies experienced in conventional approaches to detecting objects or occurrences of interest in video data. In particular, various embodiments provide for the analysis of individual video frames to provide results in near real time, as may be useful for security and monitoring applications. Video data can be captured using one or more video cameras, and the individual frames transmitted to a video analysis service for processing. Task-based resources can be allocated to perform the processing for each individual frame as received. Pre-processing can be performed to determine whether there are any objects of interest, such as people, represented in the video frame. Each frame to be analyzed can then be processed using at least one recognition algorithm trained or configured to detect objects, people, faces, expressions, features, and the like. Detected objects can also have data compared against corresponding data from earlier frames to determine relevant behaviors, moods, actions, or patterns of use. Each determination can also have a corresponding confidence value. Information about the determinations and confidence levels can be provided and/or analyzed to determine whether an action should be taken. Actions can include, for example, logging information about the determinations, providing graphical elements over a corresponding live video feed, generating a notification, or generating an alarm, among other such options. Information for the determinations can also be used to apply tags to the video content, which can allow for searching and indexing of the video content based at least in part upon those tags.

Various other applications, processes and uses are presented below with respect to the various embodiments.

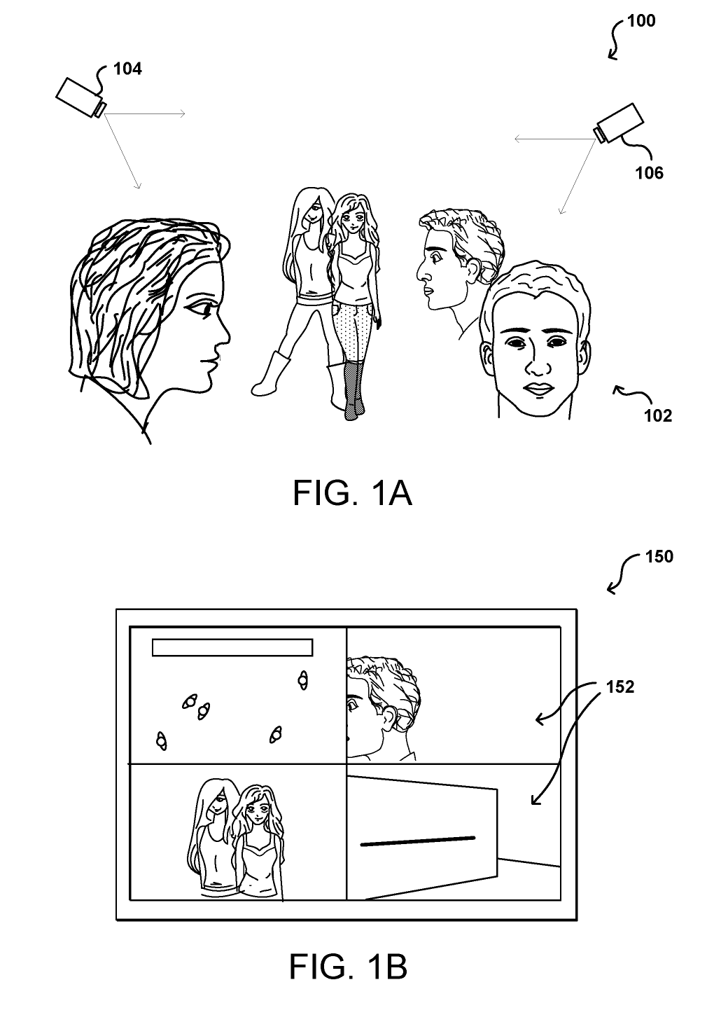

FIGS. 1A and 1B illustrate an example system for performing video monitoring that can be utilized in accordance with various embodiments. In the example situation 100 of FIG. 1A, a number of people 102 are located in an area including a set of video cameras 104, 106. These can include any appropriate cameras or image sensors, for example, such as high definition digital video cameras that capture video data in any appropriate data format. These formats can include, for example, MPEG-4, WMV, MOV, FLV, 3GP, OGG, or AVI. The cameras can also capture video data at a specific frame rate, such as 30 frames per second or 60 frames per second. It should be understood, however, that different resolutions, frame rates, formats, or other aspects can be utilized as well within the scope of the various embodiments. In this example, there are a set of video cameras 104, 106 positioned about an area with at least partially overlapping fields of view, such that an object located in the monitored area should be represented in video data captured by at least one camera. Single camera systems or cameras without overlapping fields of view can also be utilized in various embodiments.

In a conventional monitoring system, the live feed from each camera can be streamed or otherwise transmitted such that the feeds can be viewed on one or more monitoring stations. A security monitor, for example, can include a display 150 wherein the live feed 152 from one or more of the cameras can be presented for review by a human user. The display can present one feed at a time, a selection of available feeds, or a set of all feeds concurrently, although an increase in the number of feeds concurrently displayed can reduce the size of each display, which can limit the ability to detect objects of interest in the live feeds. When less than all feeds are displayed, however, it is possible that a reviewer may not notice an object of interest. Thus, a user must cycle through the feeds or the system must automatically perform such cycling. This results in only a portion of the video content being able to be reviewed at any given time. While the video data can subsequently be reviewed offline, such an approach can prevent actions being taken in real time based on the review. While an increase in the number of cameras can help to make sure objects of interest are captured from at least one point of view, the increase also can result in a decrease in the percentage of video that can be reviewed at any time, or a need to increase the resources to review the video content.

Accordingly, approaches in accordance with various embodiments can attempt to automatically detect objects, patterns, and/or behaviors of interest, among other such occurrences, in captured video data. Various approaches can also attempt to perform the analysis in near-real time, on video data as it is captured, such that the results can be displayed with the video feeds as they are displayed. The detection of objects or occurrences of interest can be brought to the attention of a human reviewer, such as security personnel, such as by selecting a view to display and/or providing additional information of interest, such as placing a bounding box or graphical indicator of the object or occurrence of interest, as well as providing information about the object or occurrence, the ability to view previously identified video data for the object or occurrence, and the like. In some embodiments, a monitoring console can provide information such as the overall mood of the people in a location, any changes in the overall mood, an indication of people with substantially different or suspicious moods, and the like. In some embodiments, the detection of certain behaviors or objects can also result in specific actions, such as calling the police or temporarily disallowing passage, among other such options.

In some embodiments, image recognition software can be utilized to detect the presence of objects or features in individual images. This can include, for example, using one or more object detection algorithms to identify objects in the images. These can include any appropriate objects, such as people, glasses, packages, weapons, products offered for consumption, and the like. Various computer vision algorithms, such as may utilize the OpenCV library or other such computer vision content, and other image processing approaches can be used for the detection or recognition, as may include feature matching or pattern recognition, among others. The image data can be analyzed and objects represented in that image data identified or classified, with the data then being reported for analysis. If it is desired to track these objects between images, then coordinate or other location information can be used as well.

As mentioned, however, these approaches work with distinct images and do not allow for video analysis. Approaches in accordance with various embodiments, however, can treat individual video frames as discrete images for purposes of applying the recognition techniques to the video content. The location and variation of these objects can also be monitored over time, for correlation as well as to detect patterns of behavior or occurrences involving those objects. This can include, for example, the behavior of a person over a period of time, the revealing of a weapon, or the placement of merchandise into a concealing object, among other such occurrences. The monitoring over time can also allow for the counting of objects of specific types at different times, in order to allow for the reporting of variations in items of interest.

An ability to automatically recognize behavioral patterns can be useful in airports, stores, public spaces, or other places where security is of concern. If someone is detected to be acting in a way that matches a suspicious behavior pattern, or is detected to be acting outside a set of expected behavior patterns, then it can be desirable in at least some embodiments to detect and identify that behavior in such a way as to allow for action to be taken in near real time. This can include, for example, generating a notification to a security personnel as to the suspicious behavior, which can allow for closer monitoring or additional action with respect to an identified person or group. The notification can also provide additional information so as to inform the security personnel as to the reason or justification for the notification. In certain circumstances, specific actions might be taken such as to call police upon the detection of a weapon or calling of store security in the event of a detected theft. In other situations, such as where a person is detected to be unusually angry or nervous, other actions might be taken such as to focus a camera on that person or alert a security professional to pay closer attention to that person, at least for a future period of time. Various other detections, notifications, and actions can be utilized as well within the scope of the various embodiments.

The behavior can be utilized for purposes other than security as well. For example, an advertiser might display content for an ad campaign at a specific location, and want to be able to determine viewers' reactions to the campaign. Accordingly, video data can be captured and analyzed to determine an overall mood of those viewers, as well as how many were happy or angry, or had other specific emotions with respect to the content. Because the analysis can be performed in near real time, this allows for changes to the campaign content to be made in response to the reactions, and the effects of those changes to be determined in near real time as the changes are being made. Facial analysis, heart rate analysis, face recognition, and other such approaches can be used to determine aspects such as emotions, mood, or expressions in at least some embodiments.

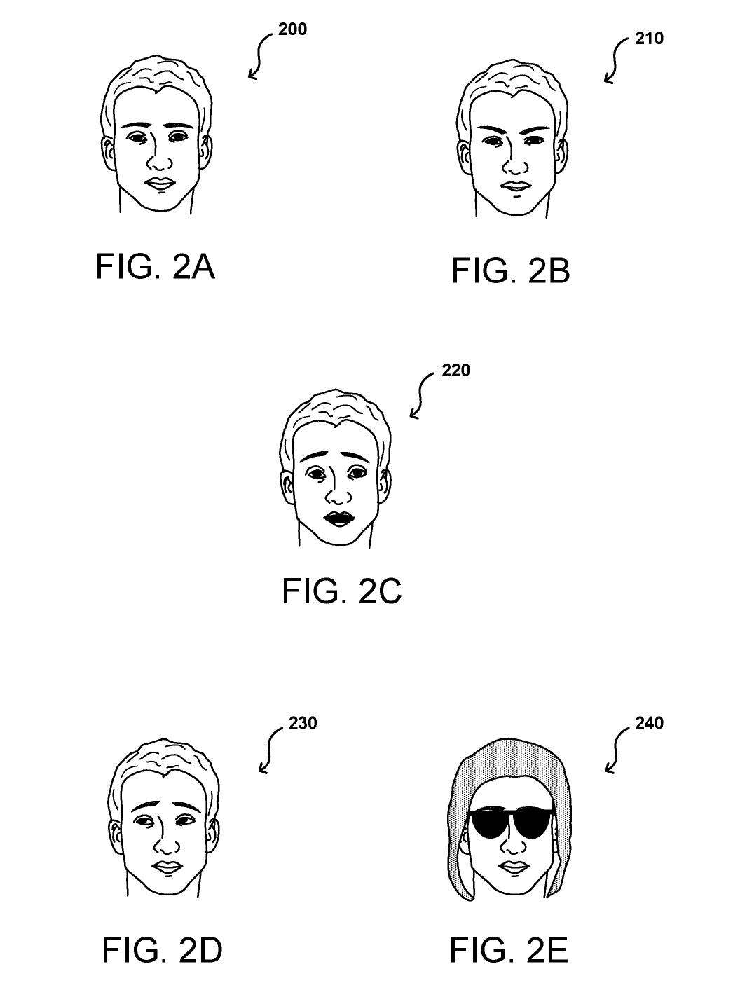

FIGS. 2A through 2E illustrate examples of behaviors or sentiments that can be determined from video content in accordance with various embodiments. Feature detection, object detection, or facial analysis can be used to determine various aspects of a person's face, body language, or movements. For facial analysis, for example, the relative locations and shapes of things like a person's lips, eyebrows, eyelids, and other such features can be indicative of the mood or sentiment of a user. As an example, the person 200 in FIG. 2A is exhibiting what might be determined to be within a normal range of behavior or sentiment, such as a content sentiment, where the eyebrows, lips, eyes, and other features of the user are near a default or relaxed position or orientation. By contrast, the person 210 in FIG. 2B has adjusted the shape of his eyebrows, eyes, and lips in such a way as to convey anger or discontent. By analyzing the difference in features (e.g., features, corners, edges, etc.) between the two faces, patterns can be determined that can indicate the user's sentiment or mood using the captured video data. As mentioned, frames of video data can be captured and analyzed in sequence over time to attempt to determine changes in mood or more accurately determine mood by analyzing the same face over a period of time. As discussed elsewhere herein, frames of video content are only one example and other time-specific representations of subsets of the video data can be analyzed or processed as well within the scope of the various embodiments. Similarly, the relative shapes of the facial features of the person 220 in FIG. 2C can indicate a mood of fear, surprise, or apprehension, and a duration of that expression can help to more accurately determine which of these moods is currently being experienced by the user.

Various other aspects or objects can be detected and/or monitored over time in order to detect potentially suspicious behavior or other types of actions. For example, the person 230 in FIG. 2D may not have facial features with relative shapes that match any specific mood, or at least a suspicious mood, but other aspects of the person can increase the confidence in a determination of suspicion. In this example, the user is not making eye contact, has his eyes darting around, and may be pacing or performing other actions that fall within a pattern of suspicious behavior. While this may be circumstantial and may not rise to the level of action, it may at least cause further attention or processing to be focused on that person. The accuracy can further be increased by taking into account typical behaviors at a specific location or for a particular task, as someone waiting to take a driver's test might normally be nervous while someone in line to buy a pack of gum should not be nervous, at least in general over a large sampling of population. Other features or objects can be used to determine a level of suspicion as well. For example, the person 240 in FIG. 2E is wearing sunglasses and has a hood over his head. While this may be normal behavior at a ski resort, for example, this may not be typical behavior for the inside of a bank or grocery store. While these factors may in and of themselves not rise to the level of a notification or alert, they can be put together with other factors in determining whether to make a notification. For example, a person wearing sunglasses in a bank may not trigger a notification if the person seems content and is following a typical path through the bank, but someone wearing sunglasses who seems nervous and is staying in an unusual region of the bank for an extended period of time might cross a behavior threshold, or satisfy a behavior criterion, that will at least cause that person to be brought to the attention of security personnel. Approaches in accordance with one embodiment can extract and analyze a set of facial features, as well as objects or states such as a presence of glasses, sunglasses, open eyes, a smile, an open mouth, a mustache, a beard, etc. In some embodiments the information can be gathered from different frames and consolidated into a report, as opposed or in addition to real time notifications and alerts.

As mentioned, in some embodiments there might be one or more suspicion thresholds applied to determine when to take an action. The facial expressions, mood, actions, behavior, apparel, and other items detected might each have a score assigned that can then be used to generate an overall suspicion score, such as might utilize a sum total, weighted average, or other function of scores to arrive at an overall score. This suspicion score, which may also come with an associated confidence score, can be compared against one or more thresholds to determine an action to be taken. For less than a first threshold, no action may be taken. For at least satisfying a first threshold, a notification can be provided to monitor a potentially suspicious person. For at least satisfying a second threshold, a security professional might be dispatched to intercept the person and make a professional determination. For at least satisfying a third threshold, the police might be called or another action taken, such as to lock down systems or perform another such action. As mentioned, minimum confidence values (e.g., at least 95% confidence) may also be required to take such an action, where the confidence value may vary with the action to be taken or threshold being exceeded, etc.

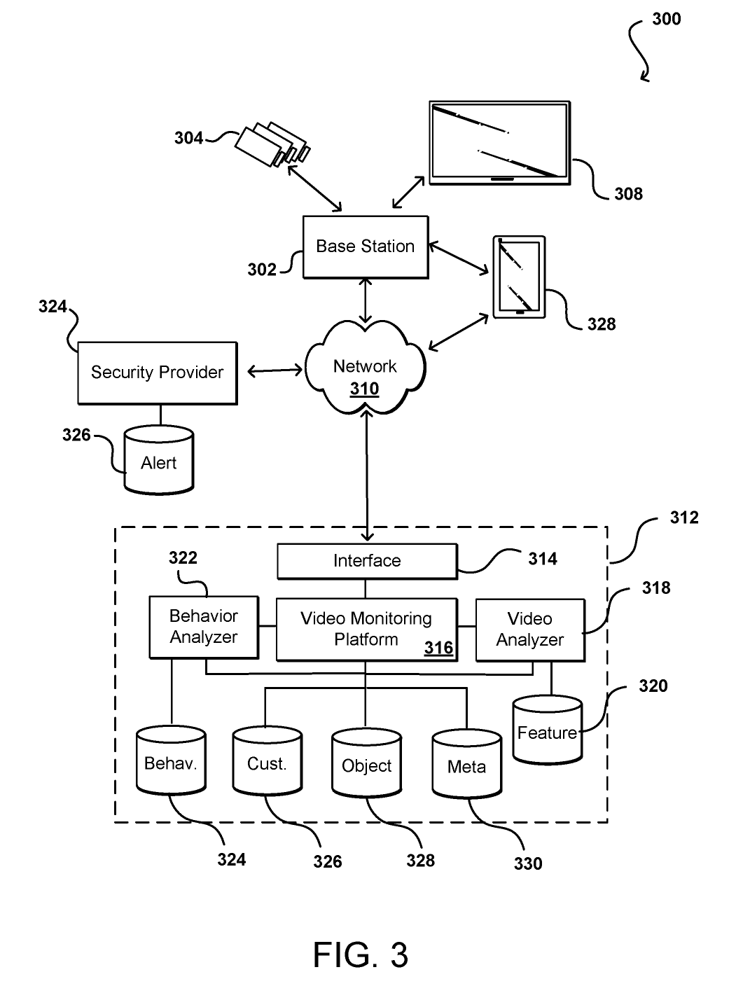

FIG. 3 illustrates an example environment 300 in which aspects of various embodiments can be implemented. In this example, a video monitoring system is utilized that includes a set of cameras 304, at least one video monitoring device 308, and a base station 302 that is at least able to receive the video data from the cameras and provide the video data to be displayed on the monitoring device 308. In some embodiments security personnel might also utilize personal computing devices 328 that are able to receive video feeds or other notifications discussed herein. The base station 302 can include one or more computing devices, such as a computer or group of networked computers, and the personal devices can include any appropriate electronic device, such as may include a smartphone, tablet computer, computer terminal, wearable computer (e.g., smart watch or glasses), and the like. While in some embodiments the base station or networked computers can perform at least some of the processing, in this example the base station can receive the video feeds and send selected frames of video data (either all or a subset of captured frames) over at least one network 310, such as the Internet, a cellular network, a local area network, and the like. As known for such purposes, a customer can utilize various devices to submit information in a request for content, such as behavior or object data, and in response the content can be identified, downloaded, streamed, or otherwise transferred to those devices. In this example, a customer can have an account with a service provider associated with a service provider environment 312. In some embodiments, the customer can utilize the service to obtain information relating to specific experiences, as may relate to security monitoring or theft prevention. In other embodiments, the service may provide information about overall mode, variations in sentiments, and the like. The service provider might provide other content as well, as may be delivered through web pages, app content, and the like.

A request for content can be received to an interface layer 314 of the service provider environment 312, where the interface layer can include components such as APIs, Web servers, network routers, and the like. The components can cause information for the request to be directed to a video monitoring platform 316, or other such component, system, or service, which can analyze information for the request to determine the processing to be performed. In this example, that can include sending the video content to a video analyzer 318 programmed and configured to detect or identify objects in the video data, such as may correspond to patterns or types of features as may be stored in a feature repository 320 and used to identify specific types of objects. As mentioned, these can include any appropriate detectable features or objects, as may relate to expressions, poses, glasses, weapons, merchandise, and the like. In this example, the object data from the video analyzer can then be passed to a behavior analyzer 322, or other such system or service, that can compare the data, and prior data for that object, against one or more behavior patterns or criteria, as may be retained in at least one behavior repository 324, which can include information for known or learned behaviors, which can be general behaviors or behaviors customized for a particular customer or location, among other such options. The behavior data and the object data can be processed by the video monitoring platform 316 in order to determine the content and/or result data to return to the base station 302. This can include, for example, analyzing rules or policies for the customer from a customer repository 326, rules or data for specific objects or occurrences from an object repository, and the analysis of any metadata stored for the customer in a metadata repository 330 that can provide information useful in determining the appropriate response. The result data can be transmitted to the base station in any appropriate form and/or format, as may include a JSON file that can be directly imported and interpreted by the base station software. In some embodiments, additional components or processes can be utilized, such as APIs to call object matching software to help track objects over time, even when those object might leave and reappear, or appear in different camera feeds. Such software can also be used to correlate objects, such as luggage or packages, with specific people or other objects.

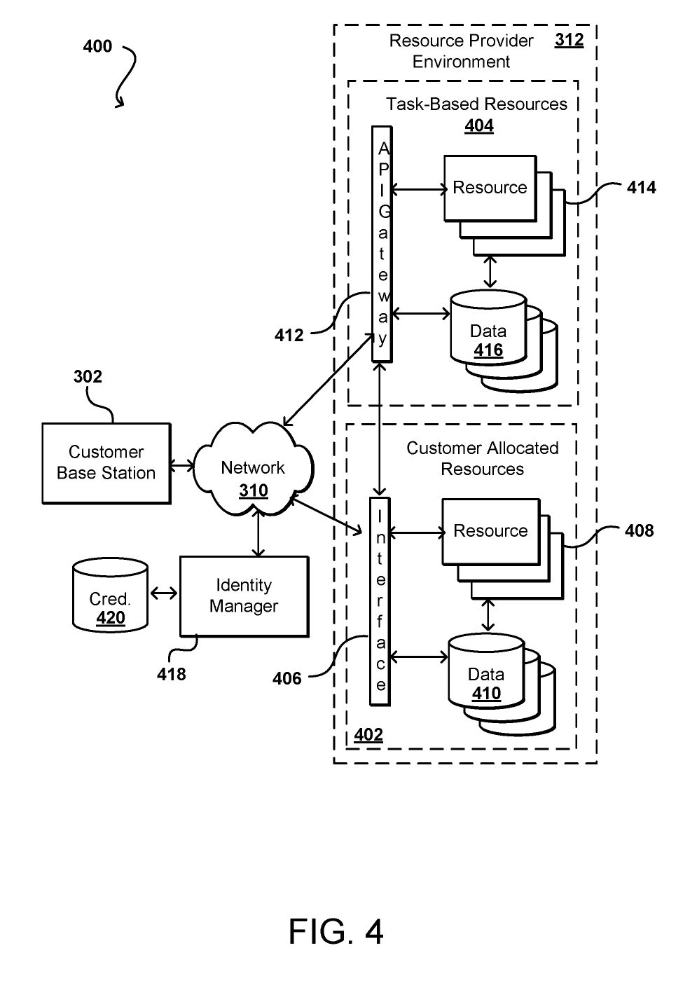

In some embodiments the data is returned to the base station which can then determine one or more actions to take, while in other embodiments the actions to take are determined by the video monitoring platform 316, which can then provide the appropriate notifications or instructions, whether to the base station 302, the device 328 of a security person on site, or a third party security provider 324, such as a security company or police department, which may maintain alert criteria in a repository 326 or other location that indicates an action to be taken in response to a particular alert or notification. Before such alerts are sent, in at least some embodiments there may be at least some level of verification, authentication, or authorization performed with respect to the request or video data. This can include, for example, obtaining temporary credentials from an identity manager 418, such as is illustrated in FIG. 4 and can maintain credential information in at least one credential repository 420. The information can include, for example, passwords, identifiers, private encryption keys, public keys, and the like. In some embodiments the identity manager also manages role and permission data, and the identity manager 418 can be part of the resource provider environment 312 in at least some embodiments. Although not illustrated in this figure, the video data may be uploaded into a bucket or cache until the video data and resources are available and ready for processing. In some embodiments the uploading of video data into a bucket will trigger the allocation of a task-specific resource as discussed in more detail elsewhere herein. In some embodiments at least some pre-processing of the video content may be performed, such as to determine whether the file is valid and satisfies any established limits or criteria for processing. In other embodiments a storage queue may be polled periodically to determine whether there is a file of processing, among other such options. Some embodiments may perform limited processing of the video frame, such as to perform a light weight facial detection procedure, before determining to perform a full set of processing on the frame. This can be useful for applications where the mood or behavior of people is of interest, but resources can be conserved by not processing video frames that do not include people (or at least partial face views of people, etc.).

As mentioned, however, analyzing large amounts of video content can be quite difficult for many systems due to the amount of resources provide. Approaches in accordance with various embodiments can attempt to significantly limit the amount of resources required by utilizing task-based resources that are only allocated on an as-needed basis and only for the type of processing needed. FIG. 4 illustrates an example environment 400 in which aspects of the various embodiments can be implemented. In this example a system such as a monitoring base station 302 is able to submit requests, including frames of video data, across at least one network 310 to a multi-tenant resource provider environment 312. It should be understood that reference numbers may be carried over between figures for similar elements for simplicity of explanation, but such usage should not be interpreted as a limitation on the scope of the various embodiments unless otherwise specifically stated. The customer device can include any appropriate electronic device operable to send and receive requests, messages, or other such information over an appropriate network and convey information back to a user of the device. Examples of such client devices include personal computers, tablet computers, smart phones, notebook computers, and the like. The at least one network 310 can include any appropriate network, including an intranet, the Internet, a cellular network, a local area network (LAN), or any other such network or combination, and communication over the network can be enabled via wired and/or wireless connections. The resource provider environment 312 can include any appropriate components for receiving requests and returning information or performing actions in response to those requests. As an example, the provider environment might include Web servers and/or application servers for receiving and processing requests, then returning data, Web pages, video, audio, or other such content or information in response to the request.

In various embodiments, the provider environment may include various types of resources that can be utilized by users for a variety of different purposes. As used herein, computing and other electronic resources utilized in a network environment can be referred to as “network resources.” These can include, for example, servers, databases, load balancers, routers, and the like, which can perform tasks such as to receive, transmit, and/or process data and/or executable instructions. In at least some embodiments, all or a portion of a given resource or set of resources might be allocated to a particular user or allocated for a particular task, for at least a determined period of time. The sharing of these multi-tenant resources from a provider environment is often referred to as resource sharing, Web services, or “cloud computing,” among other such terms and depending upon the specific environment and/or implementation. In this example the provider environment includes a plurality of resources 408 of one or more types. These types can include, for example, application servers operable to process instructions provided by a user or database servers operable to process data stored in one or more data stores 410 in response to a user request. As known for such purposes, the user can also reserve at least a portion of the data storage in a given data store. Methods for enabling a user to reserve various resources and resource instances are well known in the art, such that detailed description of the entire process, and explanation of all possible components, will not be discussed in detail herein.

In at least some embodiments, a user wanting to utilize a portion of the resources can submit a request that is received to an interface layer of the provider environment 312. The interface layer can include application programming interfaces (APIs) or other exposed interfaces enabling a user to submit requests to the provider environment. The interface layer 406 in this example can also include other components as well, such as at least one Web server, routing components, load balancers, and the like. When a request to provision a resource is received to the interface layer, information for the request can be directed to a resource manager or other such system, service, or component configured to manage user accounts and information, resource provisioning and usage, and other such aspects. A resource manager receiving the request can perform tasks such as to authenticate an identity of the user submitting the request, as well as to determine whether that user has an existing account with the resource provider, where the account data may be stored in at least one data store in the provider environment. A user can provide any of various types of credentials in order to authenticate an identity of the user to the provider. These credentials can include, for example, a username and password pair, biometric data, a digital signature, or other such information. The provider can validate this information against information stored for the user. If the user has an account with the appropriate permissions, status, etc., the resource manager can determine whether there are adequate resources available to suit the user's request, and if so can provision the resources or otherwise grant access to the corresponding portion of those resources for use by the user for an amount specified by the request. This amount can include, for example, capacity to process a single request or perform a single task, a specified period of time, or a recurring/renewable period, among other such values. If the user does not have a valid account with the provider, the user account does not enable access to the type of resources specified in the request, or another such reason is preventing the user from obtaining access to such resources, a communication can be sent to the user to enable the user to create or modify an account, or change the resources specified in the request, among other such options.

Once the user is authenticated, the account verified, and the resources allocated, the user can utilize the allocated resource(s) for the specified capacity, amount of data transfer, period of time, or other such value. In at least some embodiments, a user might provide a session token or other such credentials with subsequent requests in order to enable those requests to be processed on that user session. The customer can receive a resource identifier, specific address, or other such information that can enable the customer device to communicate with an allocated resource without having to communicate with the resource manager, at least until such time as a relevant aspect of the user account changes, the user is no longer granted access to the resource, or another such aspect changes.

The resource manager (or another such system or service) in this example can also function as a virtual layer of hardware and software components that handles control functions in addition to management actions, as may include provisioning, scaling, replication, etc. The resource manager can utilize dedicated APIs in the interface layer, where each API can be provided to receive requests for at least one specific action to be performed with respect to the data environment, such as to provision, scale, clone, or hibernate an instance. Upon receiving a request to one of the APIs, a Web services portion of the interface layer can parse or otherwise analyze the request to determine the steps or actions needed to act on or process the call. For example, a Web service call might be received that includes a request to create a data repository.

An interface layer in at least one embodiment includes a scalable set of customer-facing servers that can provide the various APIs and return the appropriate responses based on the API specifications. The interface layer also can include at least one API service layer that in one embodiment consists of stateless, replicated servers which process the externally-facing customer APIs. The interface layer can be responsible for Web service front end features such as authenticating customers based on credentials, authorizing the customer, throttling customer requests to the API servers, validating user input, and marshalling or unmarshalling requests and responses. The API layer also can be responsible for reading and writing database configuration data to/from the administration data store, in response to the API calls. In many embodiments, the Web services layer and/or API service layer will be the only externally visible component, or the only component that is visible to, and accessible by, customers of the control service. The servers of the Web services layer can be stateless and scaled horizontally as known in the art. API servers, as well as the persistent data store, can be spread across multiple data centers in a region, for example, such that the servers are resilient to single data center failures.

As mentioned, the resources in such an environment can be allocated for any of a number of different purposes for performing a variety of different tasks. The customer can provide access to the various resources to users (e.g., employees or contractors) under the credentials or roles for that account. In this example, the customer base station 302 is able to call into two different interface layers, although the interfaces could be part of a single layer or multiple layers in other embodiments. In this example, there can be a set of resources, both computing resources 408 and data resources 410, among others, allocated on behalf of the customer in the resource provider environment 312. These can be physical and/or virtual resources, but during the period of allocation the resources (or allocated portions of the resources) are only accessible using credentials associated with the customer account. These can include, for example, servers and databases that are utilized over a period of time for various customer applications. The base station 302 can also make calls into an API gateway 412, or other such interface layer, of a task-based resource environment 404, or sub-environment. In such an environment, as is discussed in more detail later herein, portions of various resources can be allocated dynamically and on a task-specific basis. There can be resources allocated to perform a specific type of processing, and those resources can be allocated on an as-needed basis where the customer is only charged for the actual processing in response to a specific task.

As mentioned, such an environment enables organizations to obtain and configure computing resources over a network such as the Internet to perform various types of computing operations (e.g., execute code, including threads, programs, software, routines, subroutines, processes, etc.). Thus, developers can quickly purchase or otherwise acquire a desired amount of computing resources without having to worry about acquiring physical machines. Such computing resources are typically purchased in the form of virtual computing resources, or virtual machine instances. These instances of virtual machines, which are hosted on physical computing devices with their own operating systems and other software components, can be utilized in the same manner as physical computers.

In many such environments, resource instances such as virtual machines are allocated to a customer (or other authorized user) for a period of time in order to process tasks on behalf of that customer. In many cases, however, a customer may not have a steady flow of work such that the customer must maintain a sufficient number of virtual machines to handle peak periods of work but will often have less than this amount of work. This can result in underutilization and unneeded expense for both the customer and the resource provider. Approaches in accordance with various embodiments can instead allocate resource instances on a task or event basis to execute a function. A resource instance can be allocated to run a function in response to a customer request or event, and once the function has completed that instance can either be made available for processing a different event or destroyed, among other such options. In either case, the customer will not be charged for more processing by the instance than was needed to run the function.

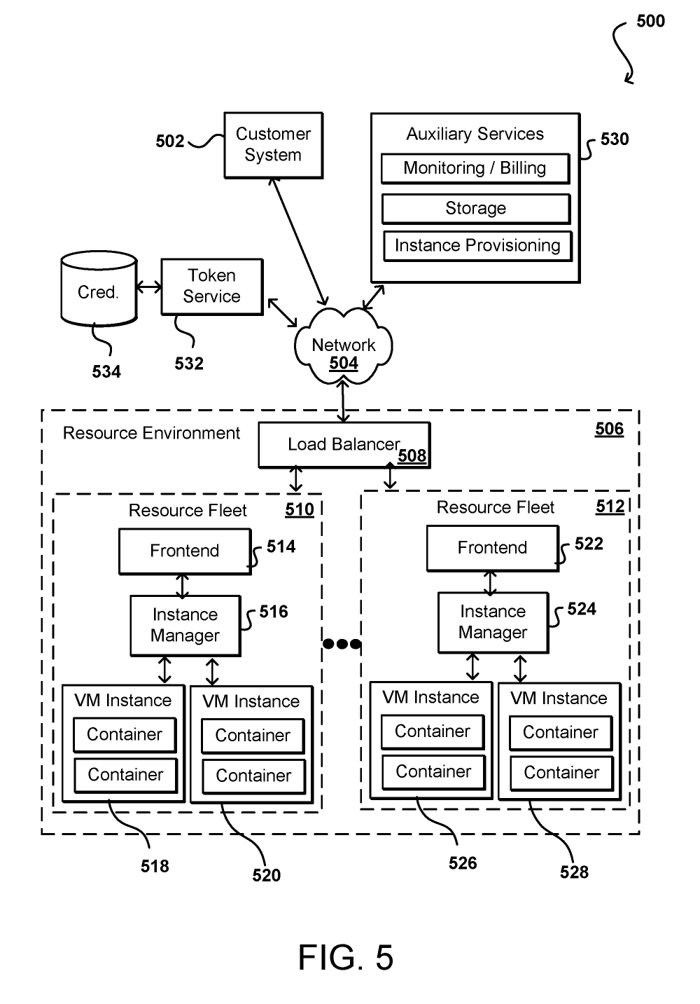

FIG. 5 illustrates components of an example environment 500 that can be used to implement such functionality. The functionality can be offered as a service, such as a Web service, in at least some embodiments, wherein a customer system 502 can submit requests or event information over at least one network 504 to the resource environment (i.e., a resource provider environment, service provider environment, or other shared resource or multi-tenant environment). The events or requests can each be associated with specific code to be executed in the resource environment. This code can be registered with the system, and will be referred to herein as a registered function, which can be owned by a respective customer or available for use by multiple customers, among other such options. The compute service offered by the resource environment can be referred to as a “serverless” compute service that can allocate virtual resources to execute registered functions in response to customer events and automatically manage the underlying compute resources. The functions can be executed on high-availability compute infrastructure that can perform the administration of the compute resources, including server and operating system maintenance, capacity provisioning and automatic scaling, code and security patch deployment, and code monitoring and logging. Customers supply the code to be executed and can be billed based on the actual amount of compute time utilized on behalf of those customers.

In some embodiments, a registered function can include the customer code as well as associated configuration information. The configuration information can include, for example, the function name and resource requirements. Registered functions can be considered to be “stateless,” in that they do not rely on state contained in the infrastructure and considered to be lacking affinity to the underlying infrastructure (e.g., the functions are not installed or otherwise tied to the operating system running in the virtual machine), so that the resource managers can rapidly launch as many copies of the function as is needed to scale to the rate of incoming events. A customer providing the code for a function can specify various configuration parameters, such as the memory, timeout period, and access rules, among other such aspects. The customer in some embodiments can also specify resources that are able to trigger execution of a registered function by a resource instance. These resources can include, for example, data buckets, database tables, or data streams, among other such options. The resource manager can invoke the code only when needed and automatically scale to support the rate of incoming requests without requiring configuration or management on behalf of the customer. A function can be executed by an allocated resource instance within milliseconds of an event in at least some embodiments, and since the service scales automatically the performance will remain consistently high as the frequency of events increases. Further, since the code is stateless the service can initialize as many resource instances as needed without lengthy deployment and configuration delays.

Routing information for customer requests or events to execute on a virtual compute fleet (e.g., a group of virtual machine instances that may be used to service such requests) based on the frequency of execution of the user code enables high frequency user code to achieve high distribution, which can be good for fault tolerance, and enables low frequency user code to achieve high consolidation, which can be good for cost reduction.

An environment such as that described with respect to FIG. 5 can facilitate the handling of requests to execute user code on a virtual compute fleet by utilizing the containers created on the virtual machine instances as compute capacity. Information for a request or event can be received to a load balancer 508 that can determine an appropriate resource fleet 510, 512 to which to direct the information. As will be discussed in more detail later herein, the decision can be based upon various types of information, as may include the context associated with the type of event or request. Upon receiving a request to execute user code on a selected virtual compute fleet 510, 512, a frontend service 514, 522 associated with the virtual compute fleet can provide the information to an instance manager, which can direct the information to a virtual machine (VM) instance 518, 520, 526, 528 where a container on the instance can provide an execution environment for the registered function.

The client device 502 may utilize one or more user interfaces, command-line interfaces (CLIs), application programing interfaces (APIs), and/or other programmatic interfaces for generating and uploading customer code, invoking the customer code (e.g., submitting a request to execute the code on the virtual compute system), scheduling event-based jobs or timed jobs, tracking the customer code, and/or viewing other logging or monitoring information related to their requests and/or customer code. Although one or more embodiments may be described herein as using a user interface, it should be appreciated that such embodiments may, additionally or alternatively, use any CLIs, APIs, or other programmatic interfaces.

In the example of FIG. 5, the resource environment 506 is illustrated as being connected to at least one network 504. In some embodiments, any of the components within the recourse environment can communicate with other components (e.g., client computing devices 502 and auxiliary services 530, which may include monitoring/logging/billing services, storage service, an instance provisioning service, and/or other services that may communicate with components or services of the resource environment 506. In other embodiments, only certain components such as the load balancer 508 and/or the frontends 514, 522 may be connected to the network 504, and other components of the virtual resource service (i.e., components of the resource fleets) may communicate with other components of the resource environment 506 via the load balancer 508 and/or the frontends 514, 522.

Customer may use the resource fleets 510, 512 to execute user code thereon. For example, a customer may wish to run a piece of code in connection with a web or mobile application that the customer has developed. One way of running the code would be to acquire virtual machine instances from service providers who provide infrastructure as a service, configure the virtual machine instances to suit the customer's needs, and use the configured virtual machine instances to run the code. Alternatively, the customer may send the resource service a code execution request. The resource service can handle the acquisition and configuration of compute capacity (e.g., containers, instances, etc., which are described in greater detail below) based on the code execution request, and execute the code using the compute capacity. The allocation may automatically scale up and down based on the volume, thereby relieving the customer from the burden of having to worry about over-utilization (e.g., acquiring too little computing resources and suffering performance issues) or under-utilization (e.g., acquiring more computing resources than necessary to run the codes, and thus overpaying).

In the configuration depicted in FIG. 5, a first resource fleet 510 includes a frontend 514, an instance manager 516 (later referred to herein as a worker manager), and virtual machine instances 518, 520. Similarly, other resource fleets 512 can also include a frontend 522, an instance manager 524, and virtual machine instances 526, 528, and there can be any appropriate number of resource fleets and any appropriate number of instances in each resource fleet. The environment can include low and high frequency fleets as well in at least some embodiments, as may serve different types of requests or requests for different types of customers. The fleets can also include any number of worker managers, and in some embodiments the frontend and the worker manager can be resident on a single virtual machine instance.

In some embodiments, the load balancer 508 serves as a front door to all the other services provided by the virtual compute system. The load balancer 508 processes requests to execute user code on the virtual compute system and handles the first level of load balancing across the frontends 514, 522. For example, the load balancer 508 may distribute the requests among the frontends 514, 522 (e.g., based on the individual capacity of the frontends). The requests can be distributed evenly across the frontends or distributed based on the available capacity on the respective fleets, among other such options.

Customer code as used herein may refer to any program code (e.g., a program, routine, subroutine, thread, etc.) written in a program language. Such customer code may be executed to achieve a specific task, for example, in connection with a particular web application or mobile application developed by the user. For example, the customer code may be written in JavaScript (node.js), Java, Python, and/or Ruby. The request may include the customer code (or the location thereof) and one or more arguments to be used for executing the customer code. For example, the customer may provide the customer code along with the request to execute the customer code. In another example, the request may identify a previously uploaded program code (e.g., using the API for uploading the code) by its name or its unique ID. In yet another example, the code may be included in the request as well as uploaded in a separate location (e.g., the external storage service or a storage system internal to the resource environment 506) prior to the request is received by the load balancer 508. The virtual compute system may vary its code execution strategy based on where the code is available at the time the request is processed.

In some embodiments, the frontend 514 for a fleet can determine that the requests are properly authorized. For example, the frontend 514 may determine whether the user associated with the request is authorized to access the customer code specified in the request. The frontend 514 may receive the request to execute such customer code in response to Hypertext Transfer Protocol Secure (HTTPS) requests from a customer, or user associated with that customer. Also, any information (e.g., headers and parameters) included in the HTTPS request may also be processed and utilized when executing the customer code. As discussed above, any other protocols, including, for example, HTTP, MQTT, and CoAP, may be used to transfer the message containing the code execution request to the frontend 514. The frontend 514 may also receive the request to execute such customer code when an event is detected, such as an event that the customer has registered to trigger automatic request generation. For example, the customer may have registered the customer code with an auxiliary service 530 and specified that whenever a particular event occurs (e.g., a new file is uploaded), the request to execute the customer code is sent to the frontend 514. Alternatively, the customer may have registered a timed job (e.g., execute the user code every 24 hours). In such an example, when the scheduled time arrives for the timed job, the request to execute the customer code may be sent to the frontend 514. In yet another example, the frontend 514 may have a queue of incoming code execution requests, and when the batch job for a customer is removed from the virtual compute system's work queue, the frontend 514 may process the customer request. In yet another example, the request may originate from another component within the resource environment 506 or other servers or services not illustrated in FIG. 5.

A customer request may specify one or more third-party libraries (including native libraries) to be used along with the customer code. In one embodiment, the customer request is a ZIP file containing the customer code and any libraries (and/or identifications of storage locations thereof) that are to be used in connection with executing the customer code. In some embodiments, the customer request includes metadata that indicates the program code to be executed, the language in which the program code is written, the customer associated with the request, and/or the computing resources (e.g., memory, etc.) to be reserved for executing the program code. For example, the program code may be provided with the request, previously uploaded by the customer, provided by the virtual compute system (e.g., standard routines), and/or provided by third parties. In some embodiments, such resource-level constraints (e.g., how much memory is to be allocated for executing a particular user code) are specified for the particular customer code, and may not vary over each execution of the customer code. In such cases, the virtual compute system may have access to such resource-level constraints before each individual request is received, and the individual requests may not specify such resource-level constraints. In some embodiments, the customer request may specify other constraints such as permission data that indicates what kind of permissions that the request has to execute the user code. Such permission data may be used by the virtual compute system to access private resources (e.g., on a private network).

In some embodiments, the customer request may specify the behavior that should be adopted for handling the customer request. In such embodiments, the customer request may include an indicator for enabling one or more execution modes in which the customer code associated with the customer request is to be executed. For example, the request may include a flag or a header for indicating whether the customer code should be executed in a debug mode in which the debugging and/or logging output that may be generated in connection with the execution of the customer code is provided back to the customer (e.g., via a console user interface). In such an example, the virtual compute system 110 may inspect the request and look for the flag or the header, and if it is present, the virtual compute system may modify the behavior (e.g., logging facilities) of the container in which the customer code is executed, and cause the output data to be provided back to the customer. In some embodiments, the behavior/mode indicators are added to the request by the user interface provided to the customer by the virtual compute system. Other features such as source code profiling, remote debugging, etc. may also be enabled or disabled based on the indication provided in the request.

The frontend 514 can receive requests to execute customer code on the virtual compute system that have been processed by the load balancer 508. The frontend 514 can request the instance manager 516 associated with the frontend 514 of the particular fleet 510 to find compute capacity in one of the virtual machine instances 518, 520 managed by the instance manager 516. The frontend 514 may include a usage data manager for determining the usage status (e.g., indicating how frequently the user code is executed) of a particular customer code, and a customer code execution manager for facilitating the execution of customer code on one of the virtual machine instances managed by the worker manager. The instance manager 516 manages the virtual machine instances in the respective fleet. After a request has been successfully processed by the load balancer 508 and the frontend 514, the instance manager 516 finds capacity to service the request to execute customer code on the virtual compute system. For example, if a container exists on a particular virtual machine instance that has the user code loaded thereon, the instance manager 516 may assign the container to the request and cause the request to be executed in the container. Alternatively, if the customer code is available in the local cache of one of the virtual machine instances, the instance manager 516 may create a new container on such an instance, assign the container to the request, and cause the customer code to be loaded and executed in the container. Otherwise, the instance manager 516 may assign a new virtual machine instance to the customer associated with the request from the pool of pre-initialized and pre-configured virtual machine instances, download the customer code onto a container created on the virtual machine instance, and cause the customer code to be executed in the container.

In some embodiments, the virtual compute system is adapted to begin execution of the customer code shortly after it is received (e.g., by the load balancer 508 or frontend 514). A time period can be determined as the difference in time between initiating execution of the customer code (e.g., in a container on a virtual machine instance associated with the customer) and receiving a request to execute the customer code (e.g., received by a frontend). The virtual compute system can be adapted to begin execution of the customer code within a time period that is less than a predetermined duration. The customer code may be downloaded from an auxiliary service 530. The data may comprise user code uploaded by one or more customers, metadata associated with such customer code, or any other data utilized by the virtual compute system to perform one or more techniques described herein. Although only the storage service is illustrated in the example of FIG. 5, the resource environment 506 may include other levels of storage systems from which the customer code may be downloaded. For example, each instance may have one or more storage systems either physically (e.g., a local storage resident on the physical computing system on which the instance is running) or logically (e.g., a network-attached storage system in network communication with the instance and provided within or outside of the virtual compute system) associated with the instance on which the container is created. Alternatively, the code may be downloaded from a web-based data store provided by the storage service.

In some embodiments, once a virtual machine instance has been assigned to a particular customer, the same virtual machine instance cannot be used to service requests of any other customer. This provides security benefits to customers by preventing possible co-mingling of user resources. Alternatively, in some embodiments, multiple containers belonging to different customers (or assigned to requests associated with different customers) may co-exist on a single virtual machine instance. Such an approach may improve utilization of the available compute capacity. Although the virtual machine instances are described here as being assigned to a particular customer, in some embodiments the instances may be assigned to a group of customers, such that an instance is tied to the group of customers and any member of the group can utilize resources on the instance. For example, the customers in the same group may belong to the same security group (e.g., based on their security credentials) such that executing one member's code in a container on a particular instance after another member's code has been executed in another container on the same instance does not pose security risks. Similarly, the instance manager 516 may assign the instances and the containers according to one or more policies that dictate which requests can be executed in which containers and which instances can be assigned to which customers. An example policy may specify that instances are assigned to collections of customers who share the same account (e.g., account for accessing the services provided by the virtual compute system). In some embodiments, the requests associated with the same customer group may share the same containers (e.g., if the customer code associated therewith are identical). In some embodiments, a request does not differentiate between the different customers of the group and simply indicates the group to which the customers associated with the requests belong. In some embodiments, the virtual compute system may maintain a separate cache in which customer code is stored to serve as an intermediate level of caching system between the local cache of the virtual machine instances and a web-based network storage (e.g., accessible via the network 504).

The instance manager 516 may also manage creation, preparation, and configuration of containers within virtual machine instances. Containers can be logical units within a virtual machine instance and utilize resources of the virtual machine instances to execute customer code. Based on configuration information associated with a request to execute customer code, such a container manager can create containers inside a virtual machine instance. In one embodiment, such containers are implemented as Linux containers.

After the customer code has been executed, the instance manager 516 may tear down the container used to execute the user code to free up the resources it occupied to be used for other containers in the instance. Alternatively, the instance manager 516 may keep the container running to use it to service additional requests from the same customer. For example, if another request associated with the same customer code that has already been loaded in the container, the request can be assigned to the same container, thereby eliminating the delay associated with creating a new container and loading the customer code in the container. In some embodiments, the instance manager 516 may tear down the instance in which the container used to execute the customer code was created. Alternatively, the instance manager 516 may keep the instance running to use the instance to service additional requests from the same customer. The determination of whether to keep the container and/or the instance running after the user code is done executing may be based on a threshold time, the type of the user, average request volume of the user, and/or other operating conditions.

In some embodiments, the virtual compute system may provide data to one or more of the auxiliary services 530 as the system services incoming code execution requests. For example, the virtual compute system may communicate with the monitoring/logging/billing services, which may include: a monitoring service for managing monitoring information received from the virtual compute system, such as statuses of containers and instances on the virtual compute system; a logging service for managing logging information received from the virtual compute system, such as activities performed by containers and instances on the virtual compute system; and a billing service for generating billing information associated with executing customer code on the virtual compute system (e.g., based on the monitoring information and/or the logging information managed by the monitoring service and the logging service). In addition to the system-level activities that may be performed by the monitoring/logging/billing services (e.g., on behalf of the virtual compute system) as described above, the monitoring/logging/billing services may provide application-level services on behalf of the customer code executed on the virtual compute system. For example, the monitoring/logging/billing services may monitor and/or log various inputs, outputs, or other data and parameters on behalf of the customer code being executed on the virtual compute system. Although shown as a single block, the monitoring, logging, and billing services may be provided as separate services.

In some embodiments, the instance manager 516 may perform health checks on the instances and containers managed by the instance manager (e.g., an “active pool” of virtual machine instances managed by the instance manager and currently assigned to one or more customers). For example, the health checks performed by the instance manager 516 may include determining whether the instances and the containers managed by the instance manager have any issues of (1) misconfigured networking and/or startup configuration, (2) exhausted memory, (3) corrupted file system, (4) incompatible kernel, and/or any other problems that may impair the performance of the instances and the containers. In one embodiment, the instance manager 516 performs the health checks periodically. In some embodiments, the frequency of the health checks may be adjusted automatically based on the result of the health checks. In other embodiments, the frequency of the health checks may be adjusted based on customer requests. In some embodiments, the instance manager 516 may perform similar health checks on the instances and/or containers in the pool of pre-warmed virtual machine instances that are not yet assigned to any customer but ready to service incoming requests. The instances and/or the containers in such a warming pool may be managed either together with those instances and containers in the active pool or separately. In some embodiments, in the case where the health of the instances and/or the containers in the warming pool is managed separately from the active pool, a separate warming pool manager that manages the warming pool may perform the health checks described above on the instances and/or the containers in the warming pool.

The virtual machine instances can be logical in nature and implemented by a single or multiple physical computing devices. At least some of the virtual machine instances may be provisioned to provide a variety of different desired conditions depending on the needs of the user. Examples of the types of desired conditions include, but are not limited to: particular operating systems, particular language runtimes, and particular libraries that may be utilized by the user code. Additionally, one or more virtual machine instances may be provisioned generically when a desired operating condition is not specified or is otherwise not available. One skilled in the relevant art will appreciate that the virtual compute system is logical in nature and can encompass physical computing devices from various geographic regions.

The frontend 514, 522 can route code-processing requests according to a method that is different than the method used by the load balancer 508 to route requests among the frontends. For example, a frontend 514 can route the requests to the specific instance manager based on the customer code and/or based on the customer associated with the customer code. In some embodiments, the routing is determined based on a consistent-hashing scheme in which one or more parameters associated with the request (e.g., customer ID, customer code ID, etc.) are hashed according to a hash function and the request is sent to one of the instance managers that has previously been assigned to the sections of a hash ring (e.g., containing a plurality of hash values) that corresponds to the resulting hash value. For example, the instance managers can occupy one or more sections of the hash ring, and the requests can be mapped to those same hash values. In some embodiments, the hash values may be integer values, and each instance manager may be associated with one or more integer values. The one or more integer values associated with a particular instance manager may be determined based on one or more parameters associated with the instance manager (e.g., IP address, instance ID, etc.). In some embodiments, the request may be sent to the instance manager whose associated integer values are closest to, but not larger than, the hash value calculated for that request (e.g., using modulo arithmetic).

When the frontends determine that one or more instance managers have become unavailable, the frontends can associate the hash values previously associated with the one or more instance managers that have become unavailable with one or more available instance managers in another fleet. Similarly, when a new instance manager is added to a fleet, the new instance manager may take a share of the hash values associated with the existing instance managers. For example, the new instance manager may be assigned one or more sections of the hash ring that were previously assigned to the existing instance managers.

As mentioned, resource capacity can be allocated as needed to execute code or perform specific tasks, which can be allocated in response to various events. The events can include any appropriate types of events, as may be permitted by a service provider or allowed through various rules or policies, among other such options. These can include, for example, modifications to data buckets or updates to data tables, among other such options. The dynamic allocation of such capacity enables service owners to get out of the business of provisioning and managing the underlying hardware for executing code. For flexibility and efficiency in resource management, such a platform or service might not make any guarantees with respect to reusing the same containers or resource instances for running a specific instance of code, such as a registered function, for all incoming requests.

As mentioned, in order to process various types of events a resource instance for a registered function may require access to various other resources, data sources, or other relevant systems or functionality in (or outside) a resource allocation environment. In some embodiments, a function can be configured with a specified role or identity, which will have various associated permissions and privileges. A registered function can be associated with a determined role, and when a resource instance is allocated for the registered function, the resource instance can be provided with an access token, or other appropriate security credential, which can provide the access needed for that function. As illustrated in the example 500 of FIG. 5, the token can be provided by a token service 532, which can be internal or external to the resource environment 506, and may managed by the resource provider or a third party in various embodiments. The token service can store information about various types of roles and access in a credential repository 534, or other appropriate location, and in response to a request for an access token for a registered function, can determine the appropriate role and permissions and provide a corresponding access token to be provided to the allocated resource instance. The frontend 514 or instance manager 516 for a relevant resource fleet 510 can cause the configured role to be bound to the relevant host(s) when an instance of a registered function is created on that host. The role can be bound as an instance profile or other such mechanism. Once the role is bound, the resource instance can assume the bound identity for accessing various resources or dependencies, as may include various data sources, internal or external resource, or network functionality, among other such options. The resource instance can thus obtain the temporary credentials needed to execute the registered function and process the event.

Using such an identity management model, the function instances triggered by any event could thus have access to credentials with the same privileges. For example, a registered function can have input access to a specified data bucket specified in the triggering event and write access to a corresponding database table. The assigned identity role for this function could then allow any function instance to read from any available bucket from that data source and write into any available table in the relevant database. A vulnerability present in the registered lambda function (i.e., an extensible markup language (XML) external entity resolution) could allow a producer of an event to hijack the credentials for the registered function, such as by using an XML external entity attack and retrieving the credentials from a local metadata endpoint for the data source. The security breach might then spread across the buckets of all function owners as well as all available tables in the database.

Accordingly, approaches in accordance with various embodiments attempt to enhance security and limit the impact of any vulnerabilities by creating and delivering temporary credentials for each event, or type of event, that can act as a trigger for a registered function. While the registered function might be associated with a role having a broader set of permissions, the temporary credentials derived therefrom can have privileges restricted to those required to process the triggering event. A function owner can define one or more parameterized access policies for his or her registered function(s) that can be based at least in part upon the types of triggering events for that registered function. The resource allocation service can use these parameterized access policies to generate policy instances corresponding to each event, and use the policy instances for creating and delivering the temporary credentials with each event.

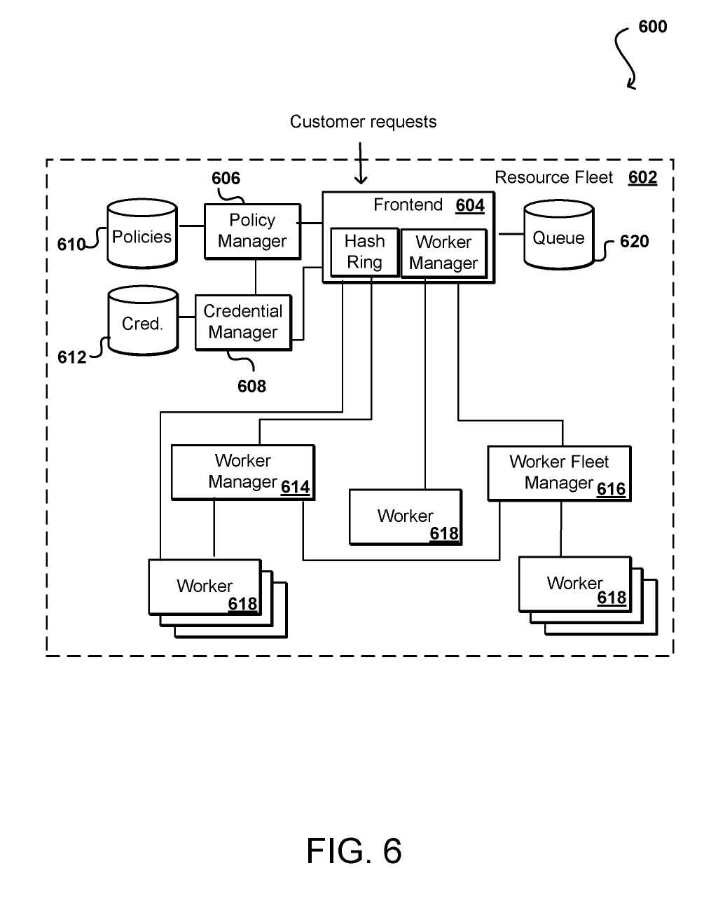

FIG. 6 illustrates an example environment 600 that can be used to implement at least some of this functionality. In this example, information for customer requests or events can be directed to a resource fleet 602. The information can be directed using a load balancer and/or interface layer as discussed previously as part of a resource allocation environment. In this example the resource instances will be referred to as “workers,” which in various embodiments can refer to the virtual machine instances 518, 520, 526, 528 described with respect to FIG. 5. It should be understood, however, that various other types of resource instances can be utilized as workers as well within the scope of the various embodiments.

As described, the frontend 604 may receive an event notification, customer request, or other event information that indicates an event has occurred for which a registered function should be utilized or processing. In this example, the frontend 604 can determine the appropriate registered function and place the event information in an event queue 620. In other embodiments the event information might be placed into the event queue before determining the registered function, or the event information might specify the registered function, among other such options. Further, in this event the frontend 604 and/or a worker manager of the frontend can place the event information in the event queue 620, while in other embodiments other worker managers 614, 616 might receive the information and place the information in the same, or a different queue, among other such options. The frontend, worker manager, or a separate queue manager can determine that a worker 618 is now available to process the event information using the respective registered function. This can include, for example, determining that a new instance should be initialized to process the event as well as allocating an existing instance, etc. The respective worker manager 614 can then allocate the relevant worker 618 for the event, pull the event information from the event queue 620, and provide the information to the allocated worker 618 for processing using the registered function.

At some subsequent point, the allocated worker 614 will complete processing for the event. This can occur for a number of different reasons as discussed elsewhere herein. The allocated instance can return a result of the processing that can be received back to the worker manager 614 and/or the frontend 604. In some embodiments the result will go to the worker manager, so the manager knows the instance is available for processing another event, and then can go to the frontend, so the frontend can provide any appropriate response or take another appropriate action.

In order to process the event, a worker 618 will have to be allocated for the relevant registered function. As mentioned, the worker will need to obtain the appropriate access credential(s) for the registered function, as may be determined by a role bound to that instance for the registered function. As mentioned, the role can provide various types of access for a determined period of time, such as fifteen minutes in some embodiments, although other lengths of time can be specified as well. Since there can be various types of triggering events for a function, the role can enable access to all relevant data for any of those events for the entire lifecycle of the function. As mentioned, however, granting all the access provided under the role can enable any vulnerability in the registered function to access data outside the scope of the registered function, and potentially exfiltrate the credentials outside of the function for various other purposes. As an example, various parsers might be used to ingest and process different types of documents, and without a security review of those parsers there is potential that parsing of an untrusted document could expose access to the function credentials.

Accordingly, approaches in accordance with various embodiments can provide event-specific credentials that are derived from an identity role bound, or otherwise associated, to the registered function for a resource instance. The necessary privileges can be provided under the role, but the restricted credentials can prevent access outside that needed to process the event. A system, component, or service such as a credential manager 608 can create a temporary token that has access only to those input and output sources required for processing the event, and can cause that token to be passed to the relevant worker 618 allocated for the event. The event-specific credential can be bound to the resource instance allocated in response to a specific event, and the permissions granted under the temporary credential determined based upon the specific event. The credential manager 608 can generate a temporary token that is event-specific, and can cause that temporary token to also be stored to a credential repository 612 or other appropriate cache such that the credentials can be passed to any other resource instance allocated for a registered function in response to the same type of event.

The event-specific credential can be generated according to the security token bound to the registered function and received from the token service in at least some embodiments. In order to determine which subset of permissions to be granted from the token, a function owner can define one or more relevant access policies that can be stored to a relevant policy data store 610 or other accessible location. A policy manager 606, or other such system or service, can work with the credential manager 608 to determine the appropriate policy for an event, which the credential manager 608 can then use to determine the appropriate permissions and generate the temporary credential to be provided to the allocated worker 618. The policy manager in some embodiments can maintain a mapping between the policies and events, in order to derive the appropriate temporary credentials from the function role. It should be understood that in at least some embodiments the policy manager 606 and/or credential manager 608 could be implemented in the frontend 604, an event router, or another such component discussed or suggested herein.

In at least some embodiments a function owner can provide a template policy which includes variables whose values will be specific to an event. This can include, for example, identifiers for the input and output data sources to which access can be granted, as well as the type of access and other such information. For each event, the available access for the relevant role can be determined, and the variable values for the event inserted into the template policy. The policy manager can then ensure that the permissions per the policy are contained within the overall permissions of the role, and if so can generate the temporary credential to be provided to the allocated worker. In some embodiments the credential manager can generate the event-specific credentials, while in other embodiments the credential manager can submit a request to the token service to receive an event-specific token, among other such options. As mentioned, the credential manager 608 can cache a received event-specific token in a local credential cache 612 to be used for other similar events for the registered function over the lifetime of the temporary credential.

In some embodiments the frontend 604 or worker manager 614 will perform a lookup to determine the relevant role for a function before performing the worker allocation. The frontend or worker manager can also, directly or via a policy manager 606, determine the appropriate template policy mapped to the specific event. The frontend or worker manager can then, directly or via the credential manager, begin filling in the template using the event-specific values. As an example, a registered function might be triggered by a notification event on a storage service, and the event can be received from any bucket on that storage service.

In some embodiments a portal can be integrated with a security service that enables a project administrator to define various roles that grant different permissions to users that assume specific roles. A given user is allowed to assume some roles, depending upon the actions that the user is permitted to perform. In some embodiments a user can only assume a single role at any time, while in others a user may be able to assume multiple non-conflicting roles. Such an approach can prevent inadvertent actions, such as the deleting of resources needed by an application, etc.

As mentioned, in various embodiments cameras can send each captured video frame, which can be analyzed using the processes discussed herein. In some embodiments, less than all of the frames can be transmitted and/or analyzed by the system. For example, a camera might perform some level of motion detection or light analysis such that frames during periods of no motion or light may not be transmitted for analysis. Some amount of comparison with respect to the prior frame might also be performed before transmission, such that only frames that are appreciably different than the previous frame are transmitted.

Various other criteria can be utilized as well. Further, the number or selection of frames transmitted can be configurable in at least some embodiments. For example, a customer might be able to specify a number of frames per second to be transmitted, whether per camera or overall between the various cameras. Such an approach can reduce the bandwidth required, but may also impact behavior monitoring. For many behaviors, however, the variations may not require an analysis of thirty frames per second. Testing of the system data over time can help to determine the number of frames per second that should be processed to achieve desirable results, where the customer in some embodiments can also potentially adjust the accuracy threshold. For example, high security areas such as airports and government buildings might tend to analyze more frames, to get higher accuracy, than might lower security areas such as hotel lobbies or grocery stores.

The video monitoring platform or other remote monitoring service may also analyze less than all the image frames that are received. As mentioned, in some embodiments an amount of pre-processing can be performed. This can include, for example, doing a light weight face detection or motion analysis, at least with respect to the last analyzed frame for a camera, to determine whether the frame should undergo a full processing and analysis. Other pre-processing approaches can be used as well, such as may relate to a number of features detected, amount of variation across the image, and the like. In some embodiments a delta can be determined between frames as part of the encoding process.

Further, the number of frames analyzed or amount of processing applied can be adjusted dynamically. For example, if the mood of a crowd is normal or content and has not changed appreciably over a recent period of time, then the amount of analysis can decrease. If a potential change is detected, however, the amount of analysis or rate of frames analyzed can increase. In some embodiments this information can be transmitted to the monitoring system such that the system transmits a corresponding number or rate of frames. Such an approach can also be done on an overall or per-camera basis, among other such options. Thus, in some situations the amount of data transmitted and/or analyzed can vary for each camera of the system. In some embodiments a capture resolution of the camera can be adjusted as well. As compression can take an amount of time, it may be easier to adjust the functional resolution of a given camera. Thus, when more detailed analysis is needed the camera can operate in a higher resolution capture mode, while when there is little or not content to analyze the camera may operate in a lower resolution capture mode, etc.

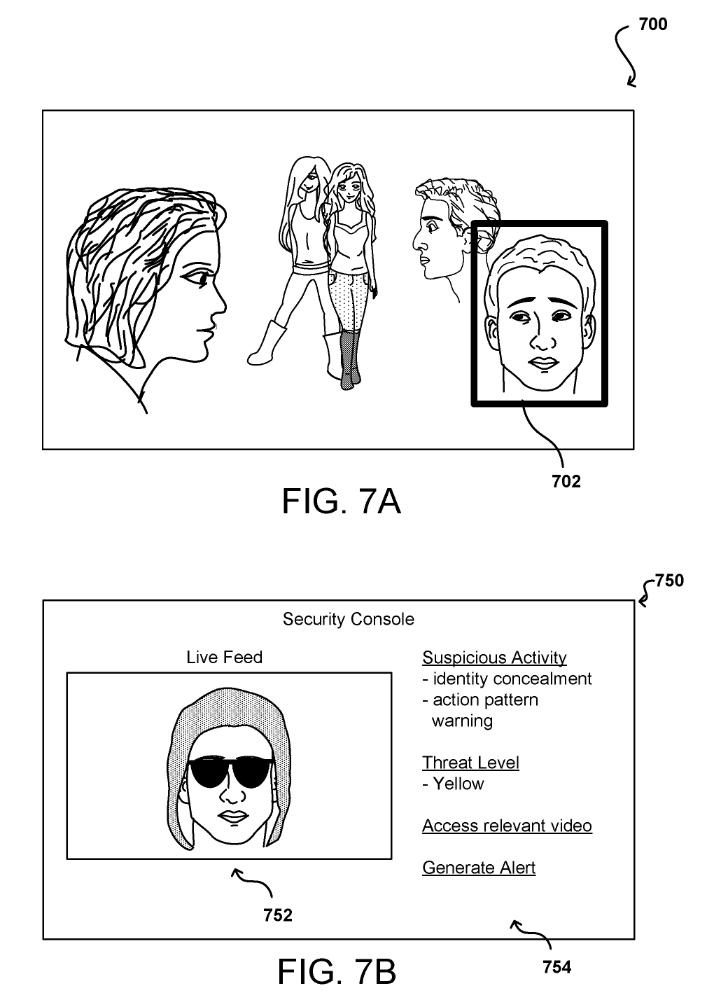

As mentioned, various different types of interfaces can be utilized to surface result or notification data to a user of the monitoring system, or other appropriate entity. FIG. 7A illustrates one example interface 700 that can be generated in accordance with various embodiments. In this example, a person determined to satisfy a suspicious behavior pattern is detected by analyzing captured video data. Accordingly, a live video feed including a current representation of the person can be selected for display to the appropriate person or on the appropriate display device(s). At least one graphical element can be rendered over the live feed to bring attention to the potentially suspicious person or activity. In this example a bounding box 702 is rendered around the representation of the suspicious person. The person can be identified in each frame, or the person can be identified and located then tracked using object tracking technology, among other such options. Further, the feature points used to identify the person can be used to determine the location and/or size of the bounding box. As the representation of the person moves, and the person changes in apparent size or shape, the bounding box can adjust accordingly. The bounding box might be used to bring attention to people exhibiting suspicious behavior or carrying suspicious objects. The color of the bounding box might change, or be selected, to designate an alert level. For example, a green bounding box might indicate someone who has met one of the triggers, or is suspicious but with a relatively low confidence level. A yellow bounding box might indicate that the person has demonstrated some suspicious behavior, or behavior of less serious types, or behavior determined to be suspicious with a reasonable level of confidence or certainty. A red bounding box might indicate that the person has met a highly suspicious behavior threshold or has exhibited behavior of a particularly dangerous type. This might go along with a security alert or call to the police, or might be the last stage or level before such an action is taken, among other such options. The threat level and bounding box color may change over time, such as where at least a minimum amount of time has passed since the suspicious behavior, object, or occurrence was detected.

FIG. 7B illustrates another example interface 750 that can be provided in accordance with various embodiments. In this example, information is provided specifically for a person who has been flagged as suspicious. This might be provided automatically upon such detection, or upon a manual selection by an operator, such as may result from an operator selecting the bounding box illustrated in FIG. 7A. In this example information is provided for the person of interest, including a live view 752 showing a representation of the person so that the person can be more easily identified. Additional information 754 can be provided as well, as may include information as to the types of suspicious activity or behavior detected, as well as a current threat level, score, or assessment. Various links or options may be provided, such as an option to view the video showing the behavior deemed to be suspicious, as may be cached locally or available to stream from the remote monitoring service. An option to generate an alert, request a security review, call police, or perform another such action may be included as well. Various other types of information may be available, and at least some level of customization possible based on operator or security personnel preference, etc. Further, in at least some embodiments operators can select the types of behaviors for which to generate notifications, or an operator can select to alert for any anomalous behavior, regardless of whether the behavior in associated with a dangerous or undesired action. Further, combinations of detected emotions with anomalous behavior can be specified as well. As mentioned, machine learning or other training approaches can be used to improve the accuracy of the determinations over time, and help to identify behaviors, actions, emotions, or occurrences that should be identified, associated with different threat levels or scores, that lead to specific actions, etc.

In some embodiments where the video footage is archived there can be various tags applied to the video automatically. These can include metadata added to the video file itself or timecode and coordinate information in a linked file, among other such options. Such an approach can help operators to locate specific behaviors or actions, or more quickly go through actions determined over a period of time. An operator can search for specific behaviors, cycle through detections or alerts, etc. A video indexing tool can be used in some embodiments that can enable a user to search for video clips showing specific behavior or alerts, for example, and can enable fast locating of related video and data, among other such options. In some embodiments a user can be presented with a set of tags, and can select a tag to locate associated video content. If facial recognition (or other person identifying technology) is used, such an approach can also help to locate any time a specific person is represented in the video content, whether or not the identify of that person is known.

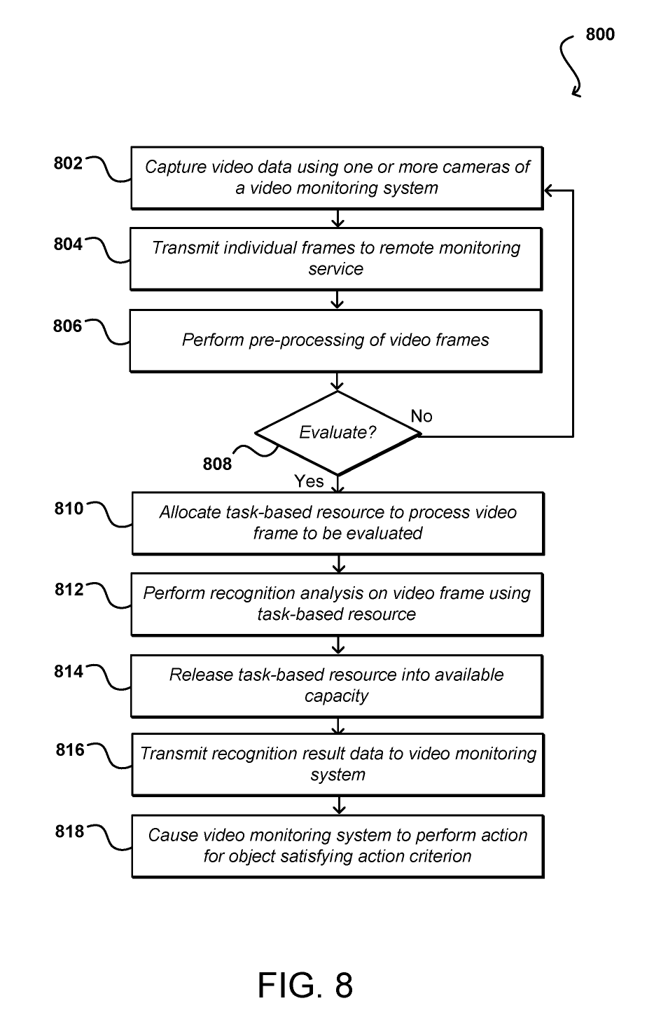

FIG. 8 illustrates an example process 800 for performing object detection in live video that can be utilized in accordance with various embodiments. It should be understood that, for any process discussed herein, there can be additional, fewer, or alternative steps performed in similar or alternative orders, or in parallel, within the scope of the various embodiments unless otherwise stated. In this example, video data is captured 802 using one or more video cameras of a video monitoring system. In this example, the cameras are all connected to a base station, connected server, or other such system that is able to gather the video data and perform any storage or initial processing of the video as may be required. Individual frames of video content can be transmitted 804 to a remote monitoring service, or other remote system, for analysis. As mentioned, this can include all captured video frames, selected frames, or frames that meet specific criteria, among other such options. The remote monitoring service can perform 806 at least some pre-processing of the video frames. As discussed elsewhere herein, this can include pre-processing to determine movement in a frame, the presence of faces or people, or a delta (difference in pixel values) from a prior frame, among other such options. The pre-processing in some embodiments can be performed using task-based resources that are dynamically allocated on an as-needed basis for pre-processing of individual video frames. A determination can be made 808, based on a result of the pre-processing, as to whether to evaluate the particular video frame. If not, the video content can be discarded from the remote monitoring service, or stored to persistent storage in some embodiments, and the process can continue for the next video frame. In some embodiments a response may be sent back to the base station indicating that no features of interest were detected in the video frame.

If an evaluation is to be performed, a task-based resource can be allocated 810 to process the individual video frame. In some embodiments, the type of resource allocated can depend at least in part upon the type of processing to perform, and the type of processing to perform can depend at least in part upon the results of the pre-processing. At least one type of recognition analysis can be performed 812 on the video frame using the task-based resource. This can include, for example, object recognition, feature recognition, facial recognition, and the like. In some embodiments multiple task-based resources can be allocated that will each perform a different type of analysis on a given frame of video content. Once processing of the frame has completed, the task-based resource can be released 814 back into available capacity. The recognition result can be transmitted 816 to the video monitoring system. The result can be any appropriate result data in any appropriate format as discussed elsewhere herein, as may include information about a type of object of interest, a threat level, a confidence level, location data, and the like. In some embodiments the data will include instructions for actions to be taken, while in other embodiments the decisions on actions to be taken can be made by the base station (or an operator of the base station) based on the received data, among other such options. The video monitoring system, or components in communication there with, can then be caused 818 to perform the determined action(s) for the object satisfying one or more action criteria. The actions can include, for example, providing identifying information on a display monitor, notifying security personnel, logging occurrence data, or calling an external security source, among other such options.

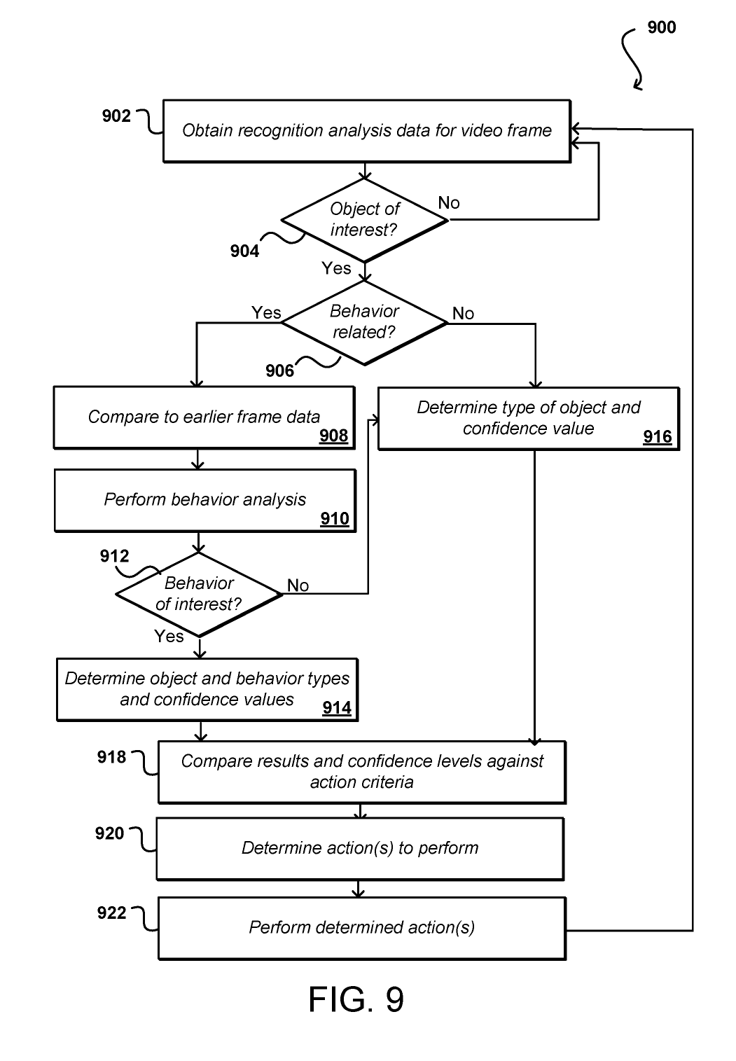

FIG. 9 illustrates an example process 900 for determining actions to take for detected objects or behaviors that can be utilized in accordance with various embodiments. In this example, recognition analysis result data is obtained 902 for a video frame captured using a camera of a video surveillance system. The result data can be analyzed to determine 904 whether there is at least one object of interest represented in the video. This can include, for example, an object of an identified type, an person with a particular type of emotion demonstrated, a person performing a specific type of action, or a person having previously been identified as performing a suspicious activity, among other such options. In some embodiments a person is always identified as an object of interest in order to perform behavior and/or mood analysis, among other such options. If there is no object of interest then the process can continue for the next video frame. If an object of interest is located, a determination can be made 906 as to whether the object is behavior related such that the object should be analyzed over a period of time.

If the object is of a type that is determined to be behavior related, such as a person, the object result data can be compared 908 against corresponding data from one or more previous video frames in which that object was detected or can be correlated. This can be based upon tag data or other tracking information. Behavior analysis can be performed 910 with respect to the data for the object in the identified video frames. As mentioned, these frames can have come from one or more cameras, and can been captured sequentially or in overlapping order by multiple cameras. The behavior can attempt to determine whether the object exhibits a behavior that is anomalous, or falls outside a set of expected behaviors, or falls within a type of behavior that has been designated as being of interest. If it is determined 912 that the behavior is not of interest then information about the object of interest itself, such as the type of object and confidence value, can be determined if not previously determined from a prior frame. If the behavior is of interest, then the types of the object and the behavior can be determined or identified, as well as the associated confidence values for each type. Other information can be determined as well, such as may include a threat level, the video frame(s) for the behavior, coordinate or location information, and the like. Once the types, confidence, and other relevant information are obtained, the values can be compared 918 against one or more action criteria or other such thresholds to determine 920 one or more actions to perform. The actions can include, for example, providing an indicator on a display, generating a notification, contacting security personnel, or triggering an alert, among other such options. As mentioned, the system may be used for purposes such as mood determination or tracking rather than security, so the action may be to update a data repository or change an aspect of the content triggering the emotion, etc. The determined action(s) then can be performed 922 as appropriate.

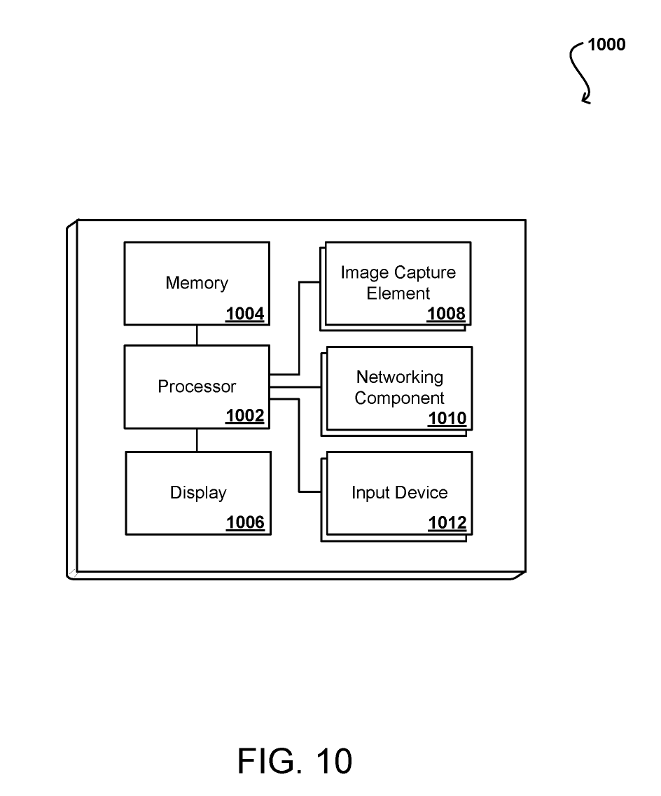

FIG. 10 illustrates a set of basic components of a computing device 1000 that can be used to implement aspects of the various embodiments. In this example, the device includes at least one processor 1002 for executing instructions that can be stored in a memory device or element 1004. As would be apparent to one of ordinary skill in the art, the device can include many types of memory, data storage or computer-readable media, such as a first data storage for program instructions for execution by the at least one processor 1002, the same or separate storage can be used for images or data, a removable memory can be available for sharing information with other devices, and any number of communication approaches can be available for sharing with other devices. The device typically will include at least one type of display element 1006, such as a touch screen, electronic ink (e-ink), organic light emitting diode (OLED) or liquid crystal display (LCD), although devices such as portable media players might convey information via other means, such as through audio speakers. As discussed, the device in many embodiments will include at least one image capture element 1008, such as at least one image capture element positioned to determine a relative position of a viewer and at least one image capture element operable to image a user, people, or other viewable objects in the vicinity of the device. An image capture element can include any appropriate technology, such as a CCD image capture element having a sufficient resolution, focal range and viewable area, to capture an image of the user when the user is operating the device. Methods for capturing images or video using an image capture element with a computing device are well known in the art and will not be discussed herein in detail. It should be understood that image capture can be performed using a single image, multiple images, periodic imaging, continuous image capturing, image streaming, etc. The device can include at least one networking component 1010 as well, and may include one or more components enabling communication across at least one network, such as a cellular network, Internet, intranet, extranet, local area network, Wi-Fi, and the like.

The device can include at least one motion and/or orientation determining element, such as an accelerometer, digital compass, electronic gyroscope, or inertial sensor, which can assist in determining movement or other changes in orientation of the device. The device can include at least one additional input device 1012 able to receive conventional input from a user. This conventional input can include, for example, a push button, touch pad, touch screen, wheel, joystick, keyboard, mouse, trackball, keypad or any other such device or element whereby a user can input a command to the device. These I/O devices could even be connected by a wireless infrared or Bluetooth or other link as well in some embodiments. In some embodiments, however, such a device might not include any buttons at all and might be controlled only through a combination of visual and audio commands such that a user can control the device without having to be in contact with the device.

The various embodiments can be implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices will also typically include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, including storage media and other non-transitory media, such as, but not limited to, volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computer-implemented method, comprising:
receiving, from a video surveillance system, video data captured using at least one camera;
allocating, for each frame of the video data to be processed, resource capacity for processing the frame of video data;
releasing the resource capacity after the frame of video data is processed;
determining a presence of one or more objects, of a plurality of types of objects of interest, represented in the video data; and
providing information about the one or more objects to the video surveillance system.

2. The computer-implemented method of claim 1, further comprising:
tracking at least one of the presence or a usage of the one or more objects over a period of time, wherein the information about the one or more items includes information about at least one of the presence or the usage over the period of time.

3. The computer-implemented method of claim 2, further comprising:
determining that the usage of a specified object of the one or more objects either falls outside an pattern of expected usage or falls within a pattern of suspicious usage; and
performing a specified action corresponding to the respective pattern of usage.

4. The computer-implemented method of claim 3, wherein the one or more objects relate to visible aspects of a person, and wherein at least one of the presence or the usage of the one or more objects corresponds to a type of behavior, a type of action taken, a mood, or an emotion.

5. The computer-implemented method of claim 3, further comprising:
comparing the type of an object of interest and a confidence level for the object of interest against one or more action criteria; and
determining the specified action based at least in part upon the one or more action criteria satisfied for the object of interest.

6. The computer-implemented method of claim 1, further comprising:
generating one or more tags for the one or more objects;
causing the one or more tags to be associated with the video data; and
enabling a search of the image data based at least in part upon specification of at least one tag of the one or more tags associated with the image data.

7. A computer-implemented method, comprising:
analyzing a frame of video data captured using a selected camera;
detecting features of a person represented in the frame of video data;
comparing a state of the features against at least one prior state of the features detected in at least one prior video frame to determine a pattern of behavior of the person;
determining that the pattern of behavior meets at least one action criterion; and
causing an action to be taken for the pattern of behavior according to the at least one action criterion.

8. The computer-implemented method of claim 7, further comprising:
providing, for the action, at least one of identifying information for the person or information for the pattern of behavior.

9. The computer-implemented method of claim 8, further comprising:
determining the action based at least in part upon the at least one action criterion satisfied for the pattern of behavior, the action including at least one of logging information, tagging the video data, displaying action data, displaying at least one graphical element over a live feed of video data, sending a notification, generating an alarm, or contacting an external entity.

10. The computer-implemented method of claim 7, further comprising:
receiving the frame of video data;
allocating an amount of task-specific resource capacity to analyze the frame of video data; and
releasing the amount of task-specific resource capacity after analyzing the frame of video data.

11. The computer-implemented method of claim 10, further comprising:
performing pre-processing of the frame of video data to determine a presence of at least one person represented in the frame of video data before analyzing the frame of video data.

12. The computer-implemented method of claim 7, further comprising:
detecting a type of an object of interest represented in the frame of video data;
determining that the type of the object of interest satisfies the at least one action criterion; and
causing a second action to be taken for the type of the object of interest according to the at least one action criterion.

13. The computer-implemented method of claim 12, wherein the object of interest is one of a facial feature, an accessory, an apparel item, a piece of merchandise, a weapon, or a person.

14. The computer-implemented method of claim 7, further comprising:
generating one or more tags for the person represented in the frame of video data;
causing the one or more tags to be associated with the video data; and
enabling a search of the video data based at least in part upon specification of at least one tag of the one or more tags associated with the image data.

15. The computer-implemented method of claim 7, further comprising:
causing an identifier to be displayed proximate the person as represented in a live view of video data, at least one aspect of the identifier indicating a level of threat of the person as determined based at least in part upon the pattern of behavior.

16. A system, comprising:
at least one processor;
memory including instructions that, when executed by the at least one processor, cause the computing system to:
receive, from a video capture system, video data captured using at least one camera;
allocate, for each frame of the video data to be processed, resource capacity for processing the frame of video data;
release the resource capacity after the frame of video data is processed;
determine a presence of one or more objects, of a plurality of objects of interest, represented in the video data; and
provide information about the one or more objects to the video capture system.

17. The system of claim 16, wherein the instructions when executed further cause the computing device to:
track at least one of the presence or a usage of the one or more objects over a period of time, wherein the information about the one or more items includes information about at least one of the presence or the usage over the period of time;
determine that the usage of a specified object of the one or more objects either falls outside an pattern of expected usage or falls within a pattern of suspicious usage; and
perform a specified action corresponding to the respective pattern of usage.

18. The system of claim 17, wherein the one or more objects relate to visible aspects of a person, and wherein at least one of the presence or the usage of the one or more objects corresponds to a type of behavior, a type of action taken, a mood, a sentiment, or an emotion.

19. The system of claim 16, wherein the instructions when executed further cause the computing device to:
compare the type of an object of interest and a confidence level for the object of interest against one or more action criteria; and
determine the specified action based at least in part upon the one or more action criteria satisfied for the object of interest.

20. The system of claim 16, wherein the instructions when executed further cause the computing device to:
generate one or more tags for the one or more objects;
cause the one or more tags to be associated with the video data; and
enable a search of the image data based at least in part upon specification of at least one tag of the one or more tags associated with the image data.
